(19) United States
(12) Patent Application Publication
(10) Pub. No.: US 2019/0204347 A1
(43) Pub. Date: Jul. 4, 2019

(54) Automated analyzer and retesting instruction system

(71) Applicant: JEOL Ltd., Tokyo (JP)

(72) Inventor: Shinichi Tomii, Tokyo (JP)

(21) Appl. No.: 16/234,910

(22) Filed: Dec. 28, 2018

(30) Foreign Application Priority Data
Jan. 4, 2018 (JP) 2018-000091

(51) Int. Cl. G01N 35/00; G01N 35/10; G01N 35/02

(52) U.S. Cl. CPC G01N 35/00732; G01N 2035/00891; G01N 35/025; G01N 35/1002

(57) ABSTRACT

A biochemical analyzer has a control section which outputs the results of analysis of measurement values from a reactant measured by a multi-wavelength photometer to a host device through a communication section. The control section causes both analyte identification information for identifying the analyte instructed to be retested through the communication section from the host device and analyte receptacle positional information indicative of the position of a sample receptacle receiving the analyte instructed to be retested from the host device on a sample turntable to be displayed on a display unit.

### BACKGROUND OF THE INVENTION

### 1. Field of the Invention

The present invention relates to an automated analyzer for analyzing components of an analyte by reacting it with a reagent or reagents. The invention also relates to a retesting instruction system.

### 2. Description of the Related Art

Biochemical analyzers for analyzing various components present in a raw analyte (hereinafter may be abbreviated as “analyte”) such as blood or urine are known as one type of automated analyzer. In such a biochemical analyzer, an analyte such as serum, urine, or the like is diluted under certain conditions and then dispensed as aliquots into reaction receptacles. The aliquots of analyte are mixed and reacted with reagents selected according to items of analysis within the reaction receptacles. The biochemical analyzer performs an analysis of a substance under measurement and present in the analyte by measuring the absorbances of the diluted analyte aliquots in the reaction receptacles and converting the absorbances into concentrations.

In the past, in almost all facilities, automated analyzers such as biochemical analyzers have been connected with host devices. A laboratory technician who uses an automated analyzer checks the results of analysis on the host device and makes a decision as to whether retesting is needed using a processing flow as illustrated in FIG. 1, which will be referenced later.

### <Conventional Flow of Processing Between Automated Analyzer and Host Device>

FIG. 1 is a sequence diagram representing one conventional flow of processing between an automated analyzer and a host device. First, the automated analyzer sends an inspection request message to the host device (S1). Then, the host device transmits inspection request information to the automated analyzer (S2). The automated analyzer starts to analyze an analyte for which the request information has been received from the host device.

When performing a first analysis (first inspection) of the analyte, the automated analyzer transmits the results of the first analysis to the host device (S3). Then, the laboratory technician checks the results of analysis displayed on the host device and makes a decision as to whether retesting is needed. The technician then searches a turntable or rack for the analyte that has been judged to require retesting, and checks the state of the analyte. Then, the technician manipulates the host device and enters a request for items of inspection regarding the analyte to be retested. The technician then enters instructions for starting retesting into the automated analyzer. If the instructions for starting retesting are entered, the automated analyzer initiates retesting. The automated analyzer then sends a retesting inquiry to the host device (S4).

The host device sends retesting instructions (i.e., information indicating what measurement items are analyzed for what analyte) to the automated analyzer (S5).

Upon receipt of the retesting instructions sent from the host device, the automated analyzer starts retesting of the analyte whose state has been checked by the laboratory technician.

Techniques for searching for the analyte instructed to be retested are disclosed, for example, in patent documents 1 and 2. Patent document 1 sets forth that if it is determined that an analyte needs to be retested, a testing information management device sends out retesting necessity/unnecessity decision result notification data containing the ID of the analyte and information indicating necessity of retesting.

Patent document 2 sets forth that an analyte recommended to be retested is displayed in highlighted form and that retesting recommendation information is sent to a doctor's computer terminal such that the doctor makes a decision as to whether or not retesting is needed.

### CITATION LIST

### Patent Documents

Patent document 1: JP-A-2010-236952

Patent document 2: JP-A-2010-256260

If the analyte needs to be retested, the laboratory technician makes a note of analyte identification information, such as patient name and host receipt number, that is necessary to search for the analyte which is displayed on the host device and needs to be retested. Then, the technician enters the analyte identification information of which a note is made by the use of the comment search function of the automated analyzer and searches for the analyte. Sometimes, the technician searches for the analyte while checking, one by one, each set of information about the analyte name printed or maked on a barcode label stuck on the receptacle storing the analyte. Therefore, it takes much labor and time to find the analyte instructed to be retested.

Furthermore, as disclosed in patent document 1, it takes labor to search for an analyte that needs to be retested based on retesting necessity/unnecessity decision result notification data. Also, as disclosed in patent document 2, it takes labor to search for an analyte that is required to be retested. Consequently, there is a need of a technique of searching for an analyte instructed to be retested without labor.

### SUMMARY OF THE INVENTION

In view of the foregoing situations, the present invention has been made. It is an object of the present invention to reduce the labor required to search for an analyte that is instructed to be retested.

An automated analyzer associated with the present invention comprises: a display unit; a communication section capable of communicating with a host device; an analyte receptacle holding section for holding an analyte receptacle that receives an analyte to be measured; a reagent receptacle holding section for holding a reagent receptacle that receives a reagent; a reaction receptacle holding section for holding a reaction receptacle in which the analyte and the reagent are stirred together; an analyte dispenser for aspirating the analyte from the analyte receptacle and dispensing an aliquot of the analyte into the reaction receptacle; a reagent dispenser for aspirating the reagent from the reagent receptacle and dispensing an aliquot of the reagent into the reaction receptacle; a measuring section for measuring, at given measurement cycles, a reactant produced by reaction of the aliquot of the analyte in the reaction receptacle with the reagent; and a control section operative to output results of analysis of measurement values from the reactant measured by the measuring section to the host device through the communication section and to cause both analyte identification information for identification of the analyte instructed to be retested from the host device through the communication section and analyte receptacle positional information indicative of the position of the analyte receptacle receiving the analyte instructed to be retested from the host device on or in the analyte receptacle holding section to be displayed on the display unit.

According to the present invention, a laboratory technician, for example, can easily search for the analyte receptacle receiving an analyte that is instructed to be retested, based both on the analyte identification information and on the analyte receptacle positional information displayed on the display unit.

Other objects, configurations, and advantages of the present invention will become apparent from the description of the embodiments set forth hereinafter.

### BRIEF DESCRIPTION OF THE DRAWINGS

FIG. 1 is a sequence diagram illustrating one conventional flow of data transmitted and received between an automated analyzer and a host device.

FIG. 2 is a block diagram of an example of the whole configuration of an automated analysis system associated with a first embodiment of the present invention.

FIG. 3 is a schematic perspective view of a biochemical analyzer associated with the first embodiment.

FIG. 4 is a block diagram of an example of internal configurations of a controller and of a host device of the analyzer of FIG. 3.

FIG. 5 is a sequence diagram illustrating one example of flow of processing between the automated analyzer and the host device according to the first embodiment.

FIG. 6 is an explanatory view illustrating one example of displayed progress monitor associated with the first embodiment.

FIG. 7 is an explanatory view illustrating one example of displayed detailed result viewer according to a second embodiment of the invention.

FIG. 8 is an explanatory view illustrating one example of displayed reaction cell usage history according to the second embodiment.

FIG. 9 is an explanatory view illustrating one example of displayed dilution cell usage history according to the second embodiment.

### DETAILED DESCRIPTION OF THE INVENTION

Embodiments of the present invention are hereinafter described with reference to the accompanying drawings. Through the present specification and drawings, constituent components having substantially identical functions or configurations are indicated by identical reference numerals; a repetition of description thereof is omitted.

### 1. First Embodiment

### <1-1. Configuration of Automated Analysis System>

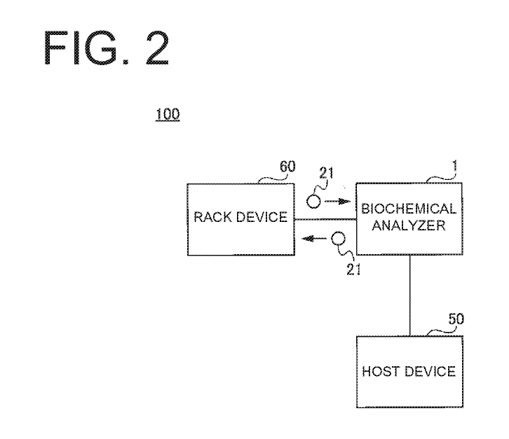

An automated analysis system associated with a first embodiment of the present invention is next described by referring to FIG. 2, which is a block diagram showing one example of the whole configuration of the automated analysis system, 100, associated with the present embodiment. The automated analysis system 100 includes a biochemical analyzer 1, a host device 50, and a rack device 60, and is used as one example of retesting instruction system in which the host device 50 can request the biochemical analyzer 1 to perform retesting of an analyte or analytes.

The biochemical analyzer 1 that is one example of the automated analyzer of the present invention is an instrument for automatically measuring the amount of a certain component present in an analyte taken from a living organism such as blood or urine. When the biochemical analyzer 1 receives a request from the host device 50, if a laboratory technician enters instructions for starting an analysis into the analyzer 1, measurement and analysis of the analyte are started. At this time, the biochemical analyzer 1 stirs together the analyte and a reagent and uses the resulting mixture in order to perform an analysis regarding an item of measurement. Furthermore, the analyzer 1 retests an analyte that is instructed to be retested from the host device 50. In addition, the analyzer 1 can perform calibration, measurement of a control analyte, and initial and repeated analyses of an analyte that needs to be measured urgently.

The host device 50 is connected with the biochemical analyzer 1 such that various data can be transmitted and received to and from the analyzer 1. The host device 50 can collect the results of analysis of the analyte from the biochemical analyzer 1 and transmit analysis requests for an initial inspection and a repeated inspection to the analyzer 1.

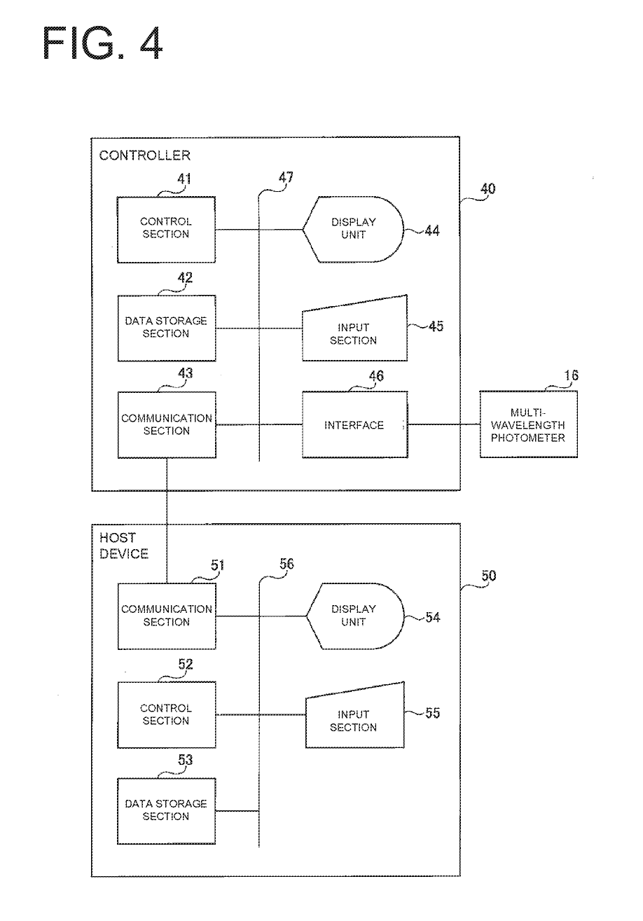

A receptacle rack device 60 that is one example of analyte receptacle holding section holds a number of sample receptacles 21 each receiving an analyte. Each sample receptacle 21 is one example of analyte receptacle. The rack device 60 loads the sample receptacles 21 into the biochemical analyzer 1 at given timings such that the contents are analyzed by the analyzer 1, and recovers the sample receptacles 21 from the analyzer 1 after the analytes received in the sample receptacle 21 are analyzed in the biochemical analyzer 1. The operation of the analyzer 1 and rack device 60 is controlled by a control section 41 (see FIG. 4 referenced later) of a controller 40. Alternatively, the biochemical analyzer 1 may receive the sample receptacles 21 from the rack device 60 and analyze the analytes received in the sample receptacles 21. Still alternatively, the analyzer 1 may analyze the analytes which have been aspirated from the sample receptacles 21 when these receptacles 21 are held in the rack device 60.

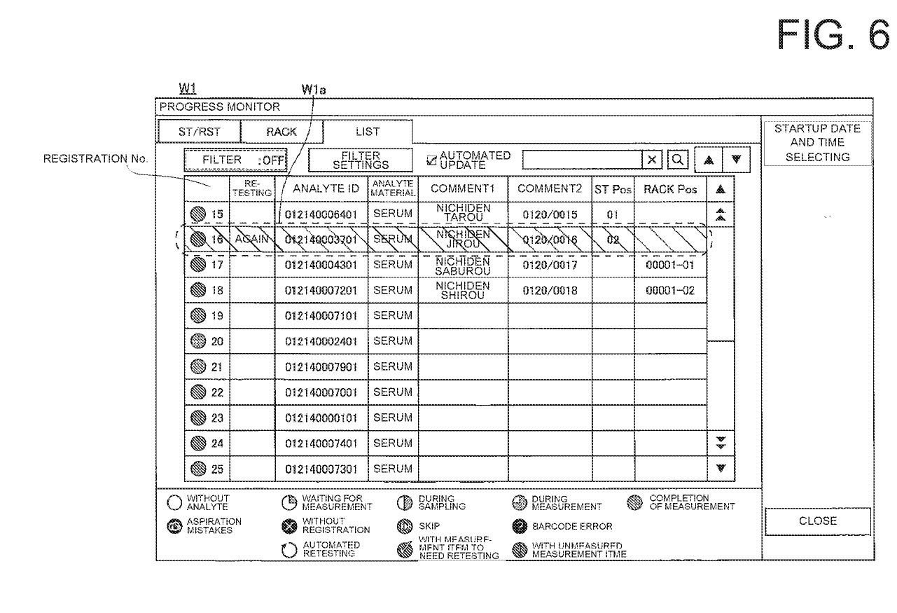

The biochemical analyzer 1 has a display unit 44 as shown in FIG. 4 which will be referenced later. A progress monitor W1 is displayed on the display unit 44 as shown in FIG. 6 which will be referenced later. Information (hereinafter may also be referred to as “retested analyte information”) uniquely representing an analyte instructed to be retested from the host device 50 is displayed within the progress monitor W1. Information about all analytes analyzed by the biochemical analyzer 1 is displayed on the display unit 44 irrespective of whether or not the information includes instructions for retesting. However, with respect to any analyte asked to be retested from the host device 50, an intelligible display or message to the effect that there is a request for retesting is provided on the display unit 44. Only information about analytes asked to be retested may be displayed on the display unit 44. With respect to an analyte instructed to be retested, information indicating at what position in the rack device 60 the sample receptacle 21 receiving this analyte is displayed in the progress monitor W1. Therefore, it is easy for the laboratory technician to search for the sample receptacle 21 receiving the analyte instructed to be retested on the basis of the retested analyte information displayed on the display unit 44 and to retest the analyte using the biochemical analyzer 1.

### <1-2. Configuration of Biochemical Analyzer>

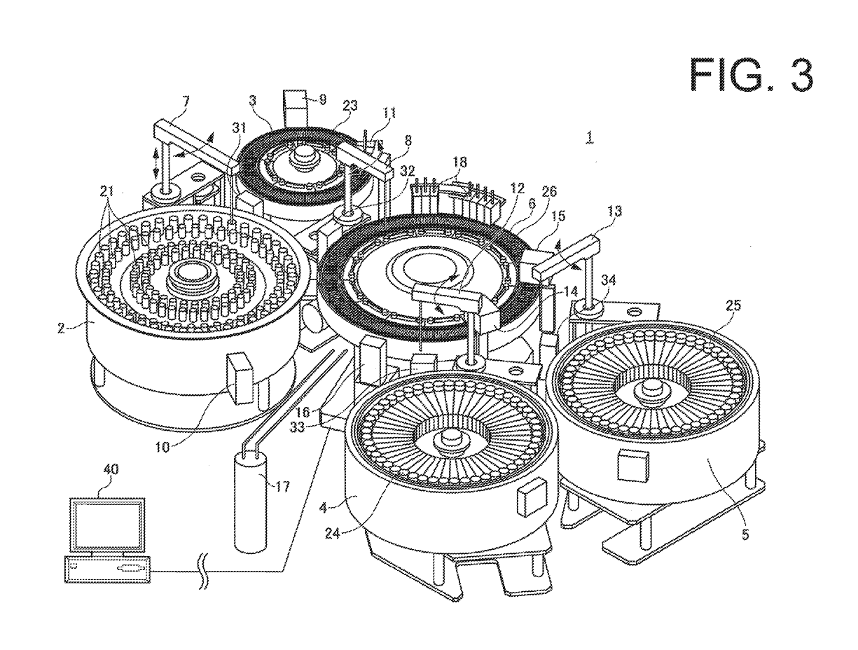

FIG. 3 schematically shows the biochemical analyzer 1. The analyzer 1 includes a sample turntable 2, a dilution turntable 3, a first reagent turntable 4, a second reagent turntable 5, and a reaction turntable 6. Furthermore, the biochemical analyzer 1 includes a raw undiluted analyte sampling probe 7, a diluted analyte sampling probe 8, a dilution and stirring mechanism 9, a sample barcode reader 10, a dilution receptacle cleaning mechanism 11, a first reagent dispensing probe 12, a second reagent dispensing probe 13, a first reaction liquid stirring mechanism 14, a second reaction liquid stirring mechanism 15, a multi-wavelength photometer 16, a thermostat bath 17, a reaction receptacle cleaning mechanism 18, and the aforementioned controller 40. In addition, the biochemical analyzer 1 includes a raw undiluted analyte sampling probe cleaning mechanism 31, a diluted analyte sampling probe cleaning mechanism 32, a first reagent probe cleaning mechanism 33, and a second reagent dispensing probe cleaning mechanism 34.

Each of the sample turntable 2, dilution turntable 3, first reagent turntable 4, second reagent turntable 5, and reaction turntable 6 is supported so as to be circumferentially rotatable by a respective drive mechanism (not shown) and rotates at a given speed in every given angular circumferential range.

The sample turntable 2 is one example of analyte receptacle holding section. A plurality of sample receptacles 21 (one example of analyte receptacle) in which analytes under measurement are received are arrayed and held circumferentially of the sample turntable 2. An analyte and a normal diluent (physiological salt solution) are received in each sample receptacle 21.

A plurality of dilution receptacles 23 are arrayed and held circumferentially of the dilution turntable 3 on the dilution turntable 3 that is one example of diluted receptacle holding section. An analyte aspirated from a selected one of the sample receptacles 21 arranged on the sample turntable 2 is diluted with a diluent, and the diluted analyte is received in a selected one of the dilution receptacles 23.

A plurality of first reagent receptacles 24 are arrayed and held circumferentially of the first reagent turntable 4 on the first reagent turntable 4 that is one example of first reagent receptacle holding section. A plurality of second reagent receptacles 25 are arrayed and held circumferentially of the second reagent turntable 5 on the second reagent turntable 5 that is one example of second reagent receptacle holding section. A first reagent is received in each first reagent receptacle 24. A second reagent is received in each second reagent receptacle 25. The first reagent received in the first reagent receptacles 24 and the second reagent received in the second reagent receptacles 25 are kept cooled at a given temperature by a refrigerating mechanism (not shown).

The reaction turntable 6 that is one example of reaction receptacle holding section is disposed among the dilution turntable 3, the first reagent turntable 4, and the second reagent turntable 5. A plurality of reaction receptacles 26 are arrayed and held circumferentially of the reaction turntable 6 on the reaction turntable 6. The reaction turntable 6 moves the held reaction receptacles 26 in steps. The diluted analyte sampled from a selected one of the dilution receptacles 23 on the dilution turntable 3, the first reagent sampled from a selected one of the first reagent receptacles 24 on the first reagent turntable 4, and the second reagent sampled from a selected one of the second reagent receptacles 25 on the second reagent turntable 5 are injected into a selected one of the reaction receptacles 26. In this reaction receptacle 26, the diluted analyte, the first reagent, and the second reagent are stirred together to induce a reaction.

The undiluted analyte sampling probe 7 that is one example of analyte dispenser is disposed close both to the sample turntable 2 and to the dilution turntable 3, and is supported so as to be movable axially (e.g., in the up and down direction) of the sample turntable 2 and of the dilution turnable 3 by a raw undiluted analyte sampling probe drive mechanism (not shown). The undiluted analyte sampling probe 7 aspirates a given amount of analyte from a selected one of the sample receptacles 21 and delivers the aspirated analyte and a given amount of diluent (e.g., physiological salt solution) supplied from the undiluted analyte sampling probe 7 itself into a selected one of the dilution receptacles 23. Consequently, in the dilution receptacle 23, the analyte is diluted by a given dilution factor up to a desired concentration. Thus, a diluted analyte is generated. In this way, the undiluted analyte sampling probe 7 dispenses an aliquot of the analyte into the dilution receptacle 23 principally in order to dilute the analyte. The undiluted analyte sampling probe 7 is cleaned by the undiluted analyte sampling probe cleaning mechanism 31 that is one example of first cleaning section mounted between the sample turntable 2 and the dilution turntable 3.

The diluted analyte sampling probe 8 that is one example of diluted analyte dispenser is disposed between the dilution turntable 3 and the reaction turntable 6, and is supported such that it can be moved axially (in the up and down direction) of the dilution turnable 3 and horizontally and rotated by a diluted analyte sampling probe drive mechanism (not shown). The diluted analyte sampling probe 8 aspirates a given amount of diluted analyte from a selected one of the dilution receptacles 23 on the dilution turntable 3 and delivers the aspirated diluted analyte into a selected one of the reaction receptacles 26 on the reaction turntable 6. The diluted analyte sampling probe 8 is cleaned by the diluted analyte sampling probe cleaning mechanism 32 that is one example of second cleaning section mounted between the dilution turntable 3 and the reaction turntable 6.

The dilution and stirring mechanism 9 and the dilution receptacle cleaning mechanism 11 are arranged around the dilution turntable 3. The dilution and stirring mechanism 9 inserts its stirring rod (not shown) into a selected one of the dilution receptacles 23 and stirs together the analyte and diluent. The dilution receptacle cleaning mechanism 11 supplies a detergent from a detergent pump into dilution receptacle cleaning nozzles such that the detergent is ejected into the dilution receptacle 23 from the dilution receptacle cleaning nozzles.

The sample barcode reader 10 is mounted on the side surface of the sample turntable 2. The sample barcode reader 10 reads a barcode attached to the side surface of each sample receptacle 21 received in the sample turntable 2 and manages the analyte, diluent, and so on received in the sample receptacle 21.

The first reagent dispensing probe 12 that is one example of first reagent dispenser is disposed between the reaction turntable 6 and the first reagent turntable 4 and supported such that it can be moved axially (in the up and down direction) of the reaction turntable 6 and horizontally and rotated by a first reagent dispensing probe drive mechanism (not shown). The first reagent dispensing probe 12 aspirates a given amount of first reagent from a selected one of the first reagent receptacles 24 on the first reagent turntable 4 and delivers the aspirated first reagent into a selected one of the reaction receptacles 26 on the reaction turntable 6. The first reagent dispensing probe 12 is cleaned by the first reagent probe cleaning mechanism 33, which is one example of third cleaning section, mounted between the reaction turntable 6 and the first reagent turntable 4.

The second reagent dispensing probe 13 that is one example of second reagent dispenser is disposed between the reaction turntable 6 and the second reagent turntable 5, and is supported such that it can be moved axially (in the up and down direction) of the reaction turntable 6 and horizontally and rotated by a second reagent dispensing probe drive mechanism (not shown). The second reagent dispensing probe 13 aspirates a given amount of second reagent from a selected one of the second reagent receptacles 25 on the second reagent turntable 5 and delivers the aspirated second reagent into a selected one of the reaction receptacles 26 on the reaction turntable 6. The second reagent dispensing probe 13 is cleaned by the second reagent dispensing probe cleaning mechanism 34, which is one example of fourth cleaning section, mounted between the reaction turntable 6 and the second reagent turntable 5.

The first reaction liquid stirring mechanism 14, second reaction liquid stirring mechanism 15, and reaction receptacle cleaning mechanism 18 are arranged around the reaction turntable 6. The first reaction liquid stirring mechanism 14, which is one example of first stirring section, inserts its stirring rod (not shown) into a selected one of the reaction receptacles 26 to stir together the analyte and the first reagent. The second reaction liquid stirring mechanism 15, which is one example of second stirring section, inserts its stirring rod (not shown) into a selected one of the reaction receptacles 26 and stirs the liquid mixture of the analyte, the first reagent, and the second reagent. The reaction receptacle cleaning mechanism 18 cleans the inside of each reaction receptacle 26 for which an inspection is complete.

The multi-wavelength photometer 16 is disposed opposite to the outer peripheral wall of the reaction turntable 6 and used as a lamp operating as a light source emitting a light beam to the reaction receptacles. The multi-wavelength photometer 16 is one example of measuring section that measures, at given measurement cycles, the reactant produced by reaction of the analyte aliquot in each reaction receptacle 26a with the first and second reagents. This measurement is carried out by an optical measurement (colorimetic measurement). The multi-wavelength photometer 16 outputs numerical values indicative of the amounts of various constituents of an analyte, i.e., absorbances, and detects the state of reaction of the analyte. The controller 40 for controlling the operation of various sections of the biochemical analyzer 1 is connected with the multi-wavelength photometer 16.

The thermostat bath 17 is mounted around the reaction turntable 6 and serves to maintain constant the temperatures of the reaction receptacles 26 held on the reaction turntable 6 at all times.

### <<1-3. Configuration of Controller>>

An example of the internal configuration of the controller 40 and an example of the internal configuration of the host device 50 are next described. FIG. 4 is a block diagram showing the examples of the internal configurations of the controller 40 and of the host device 50. The controller 40 includes the aforementioned control section 41, a data storage section 42, a communication section 43, the display unit 44, an input section 45, and an interface 46 all of which are connected with a bus 47.

The control section 41 that is one example of first control section is made of a CPU (central processing unit) or the like, and controls the operation of various portions of the biochemical analyzer 1 based on a program read from the data storage section 42. The control section 41 analyzes measurement values from a reactant measured by the multi-wavelength photometer 16 and outputs the results of analysis to the host device 50 through the communication section 43. The control section 41 displays analyte IDs for identification of analytes instructed to be retested from the host device 50 through the communication section 43 and analyte positional information on the display unit 44, the analyte receptacle positional information indicating the positions of the sample receptacles 21 receiving analytes instructed to be retested from the host device 50 on the sample turntable 2.

The data storage section 42 is made, for example, of a mass storage device such as a HDD (hard disk drive) and stores programs for the control section 41, parameters, calibration lines, input actions made through the input section 45, and so on.

The communication section 43 that is one example of first communication section can send and receive various data to and from the communication section 51 of the host device 50. For example, the communication section 43 sends results of analysis of analytes to the host device 50 and receives measurement item information and instructions for retesting from the host device 50.

The display unit 44 that is one example of first display section displays the results of analysis of the liquid mixture of an analyte, a first reagent, and a second reagent as well as other information. For example, a liquid crystal display is used as the display unit 44. Examples of the configurations of various screens displayed on the display unit 44 will be described later. The input section 45 accepts an input action performed by a laboratory technician on the biochemical analyzer 1 and outputs an input signal to the control section 41. For example, a mouse, a keyboard, a touch panel, or the like is used as the input section 45.

If measurement values from the liquid mixture measured by the multi-wavelength photometer 16 are entered, the interface 46 passes the measurement values to the control section 41. In the example shown in FIG. 4, only the multi-wavelength photometer 16 is connected to the interface 46. Various internal portions of the biochemical analyzer 1 are similarly connected with the interface 46 and controlled by the controller 40.

The host device 50 includes a communication section 51, a control section 52, a data storage section 53, a display unit 54, and an input section 55 all of which are connected with a bus 56.

The communication section 51 that is one example of second communication section can send and receive various data to and from the communication section 43 of the controller 40 of the biochemical analyzer 1. For example, the communication section 51 receives the results of analysis of analytes from the controller 40 and sends measurement item information and instructions for retesting to the controller 40.

The control section 52 that is one example of second control section is made of a CPU or the like and sends instructions for retesting of analytes entered by the laboratory technician through the input section 55 to the biochemical analyzer 1 through the communication section 51 based on a program read from the data storage section 53.

The data storage section 53 is made, for example, of a mass storage device such as a HDD and stores programs executable by the control section 52, input actions performed through the input section 55, and so on.

The display unit 54 that is one example of second display unit displays the results of analysis that the communication section 51 receives from the biochemical analyzer 1. For example, a liquid crystal display or the like is used as the display unit 54. The input section 55 accepts input actions performed by the laboratory technician for the host device 50 and outputs an input signal to the control section 52. If the laboratory technician manipulates the input section 55, a request for a measurement item on an analyte to be retested is entered. A mouse, a keyboard, a touch panel, or the like is used as the input section 55.

<1-4. Flow of Processing Between Biochemical Analyzer and Host Device Associated with the Present Embodiment>

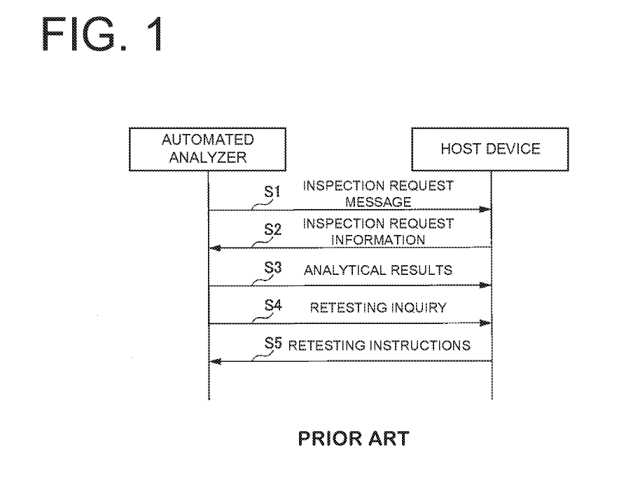

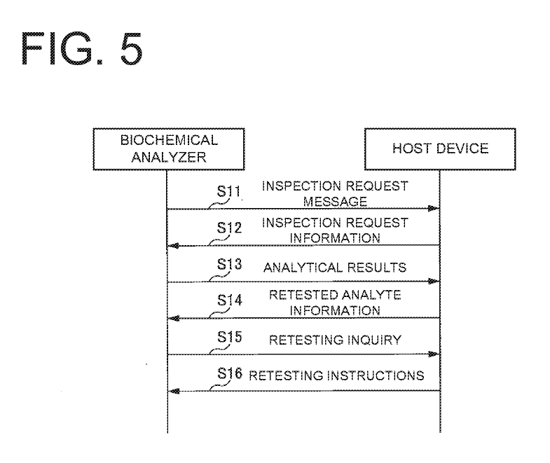

FIG. 5 is a sequence diagram illustrating an example of flow of processing between the biochemical analyzer 1 and the host device 50 associated with the present embodiment. The processing sequence of steps S11-S13 of FIG. 5 is similar to the processing sequence of steps S1 to S3 of the above-cited FIG. 1 and so a detailed description thereof is omitted.

In step S13, the results of analysis of a first analysis are sent to the host device 50 from the biochemical analyzer 1 and then the laboratory technician checks the results of analysis displayed on the host device 50 and makes a decision as to whether retesting is needed.

Then, the host device 50 sends retested analyte information to the biochemical analyzer 1 (S14), and the retested analyte information is displayed on the display unit 44 of the biochemical analyzer 1. At this time, the retested analyte information indicates at what position on the sample turntable 2 or in the rack device 60 the sample receptacle 21 receiving the analyte is located. Therefore, it is easy for the laboratory technician to search the turntable or rack device for the analyte judged to need retesting by the host device 50, and the technician can confirm the state of the analyte.

The laboratory technician then manipulates the host device 50 and enters a request for a measurement item on the retested analyte. Then, the technician enters instructions for starting of retesting into the biochemical analyzer 1, so that the analyzer 1 initiates retesting. The analyzer 1 sends a retesting inquiry to the host device 50 (S15).

Upon receipt of the retesting inquiry, the host device 50 sends instructions for retesting (i.e., information indicating what measurement item of what analyte is analyzed) to the biochemical analyzer 1 (S16). Then, the biochemical analyzer 1 performs retesting based on the retesting instructions received from the host device 50.

### <1-5. Example of Display of Progress Monitor>

FIG. 6 is an explanatory view illustrating an example of display of the progress monitor W1. The progress monitor W1 is a screen displayed on the display unit 44 of the biochemical analyzer 1 under control of the control section 41. Alternatively, the progress monitor may be displayed on the display unit 54 of the host device 50. This progress monitor W1 is one example of progress monitor screen displaying the state of analysis of the analyte and the analyte receptacle positional information.

For each Registration Number (No.), the progress monitor W1 displays information about various items including Retesting, Analyte ID, Analyte Material, Comment 1, Comment 2, ST Pos, and RACK Pos. As one example of receptacle identification information attached to uniquely identify each sample receptacle 21, a respective registration number (No.) is displayed in each item of Registration No. Furthermore, during measurement by the laboratory technician, an icon is displayed in each item of Registration No. to permit the technician to comprehend at a glance the status such as completion of the measurement. Explanatory notes regarding icons are provided at the foot of the progress monitor W1.

What is displayed in the item of Retesting is information indicating whether or not instructions for retesting are given from the host device 50, and “again” is displayed in the item of Retesting as information indicating that instructions for retesting are given to the analyte from the host device 50. Irrespective of whether or not instructions for retesting are issued from the host device 50, “again” is displayed in the item of Retesting for any analyte judged to need retesting by the biochemical analyzer 1. For example, with respect to any analyte which has not been analyzed normally because an abnormality has occurred in the biochemical analyzer 1 (e.g., the undiluted analyte sampling probe 7 has become clogged), the analyzer 1 determines that this analyte needs retesting, and “again” is displayed in the item of Retesting for this analyte.

As one example of analyte identification information attached to uniquely identify an analyte, an analyte ID is displayed in the item of Analyte ID. Information indicating the constituents (e.g., “serum”) of the analyte is displayed in the item of Analyte Material. Arbitrary comments entered by the laboratory technician are displayed in the items of Comment 1 and Comment 2.

What is displayed in the item of ST Pos (sample tray position) is information indicating at what position on the sample turntable 2 the sample receptacle 21 identified with a registration No. is received.

Information indicating at what position in the rack device 60 the sample receptacle 21 identified with a registration No. is received is displayed in the item of RACK Pos (rack position). Fundamentally, any sample receptacle 21 receiving an analyte instructed to be retested is accommodated either on the sample turntable 2 or in the rack device 60. ST Pos and RACK Pos are used as examples of analyte receptacle positional information indicative of the position of the sample receptacle 21 instructed to be retested.

In a record displayed in highlighted form with oblique lines within the progress monitor W1, if “again” is displayed in the item of Retesting, for example, of registration No. 16, it follows that the analyte received in the sample receptacle 21 with registration No. 16 is instructed to be retested. Furthermore, it is seen that the sample receptacle 21 receiving the analyte instructed to be retested is stored at the position indicated by “02” at ST Pos. Therefore, the laboratory technician can extract the sample receptacle 21 stored at the position indicated by “02” at ST Pos on the sample turntable 2 and carry out retesting of the analyte received in this sample receptacle 21.

In the automated analysis system 100 associated with the first embodiment described so far, at what position on the sample turntable 2 or in the rack device 60 the sample receptacle 21 receiving the analyte instructed to be retested from the host device 50 is located is displayed in the progress monitor W1. Therefore, the laboratory technician can quickly obtain the sample receptacle 21 receiving the analyte instructed to be retested and carry out retesting by confirming the progress monitor W1. In this way, the work done by the laboratory technician to search the sample turntable 2 or rack device 60 is facilitated. Consequently, the time taken from the issuance of instructions for retesting to the execution of retesting can be shortened.

Note that the biochemical analyzer 1 suffices to have at least one of the sample turntable 2 and the rack device 60. Therefore, the biochemical analyzer 1 may be provided with only the sample turntable 2 or only the rack device 60.

### 2. Second Embodiment

The automated analysis system 100 associated with a second embodiment of the present invention is next described. The following description centers on an example of the configuration of screen displayed on the display unit 44 of the biochemical analyzer 1.

### <2-1. Example of Display of Detailed Result Viewer>

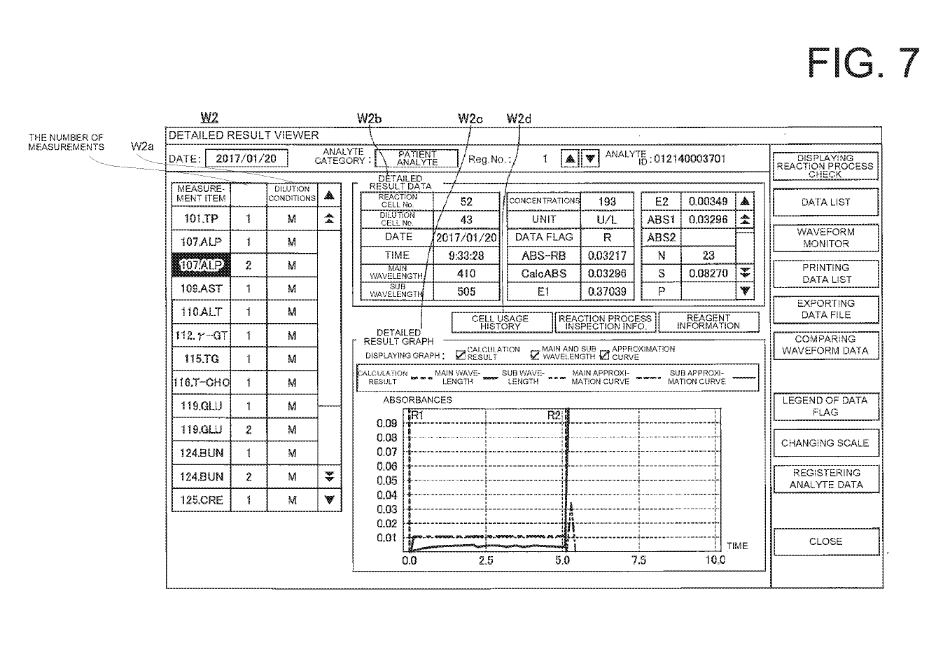

FIG. 7 is an explanatory view illustrating an example of display of a detailed result viewer W2. When information indicating that instructions for retesting from the host device 50 is displayed in the progress monitor W1, if this information is selected, the detailed result viewer W2 is shown. This viewer W2 is one example of screen that displays results of analysis. The detailed result viewer W2 is a screen displayed on the display unit 44 of the biochemical analyzer 1. Alternatively, the viewer W2 may be displayed on the display unit 54 of the host device 50.

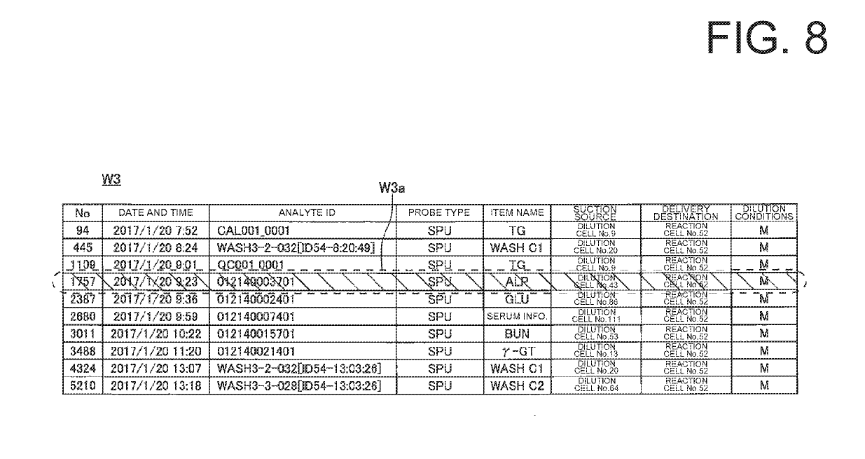

When the record containing the registration No. which is indicative of the sample receptacle 21 receiving the analyte instructed to be retested and which is displayed in the progress monitor W1 described in the first embodiment is clicked, the detailed result viewer W2 is displayed on the display unit 44. A reaction cell usage history W3 (see FIG. 8 that will be referenced later) for displaying the usage history of the reaction receptacle 26 can be selected from the detailed result viewer W2 and displayed.

What are displayed in the detailed result viewer W2 are Measurement Conditions W2a, Detailed Result Data W2b, Detailed Result Graph W2c, Cell Usage History Button W2d, and so on. What are displayed in the item of the Measurement Conditions W2a are a Measurement Item of an analyte, the Number of Measurements, and Dilution Conditions. A measurement item (107.ALP) selected by the laboratory technician is displayed in filled and highlighted form in the item of Measurement Conditions W2a.

What are displayed in each item of Detailed Result Data W2b are a measurement time regarding the measurement item of the analyte selected under the measurement conditions W2a, the position number of the dilution receptacle 23 (expressed as “dilution cell” in FIG. 7) receiving the analyte, the position number of the reaction receptacle 26 (expressed as “reaction cell” in FIG. 7), measurement date and time, measurement time, and other information.

What is displayed in Detailed Result Graph W2c is a graph representing variation of the absorbance of the measurement item selected in the measurement conditions W2a which occurs with the elapse of time.

The cell usage history button W2d is used to display the reaction cell usage history W3 shown in FIG. 8 on the display unit 44. If the laboratory technician depresses the cell usage history button W2d, reaction cell usage history W3 is displayed.

### <2-2. Example of Display of Reaction Cell Usage History>

FIG. 8 is an explanatory view illustrating an example of display of the reaction cell usage history W3. If instructions for displaying the usage history of the reaction receptacle 26 are given through the detailed result viewer W2, the control section 41 displays, on the display unit 44, both reaction receptacle positional information indicative of that position of the reaction receptacle 26 receiving the reactant instructed to be retested from the host device 50 which lies on the reaction turntable 6 and the usage history of the reaction receptacle 26. The usage history of one reaction receptacle 26 is information displayed for every measurement date and time at which the reactant was measured, for example, using this specific reaction receptacle 26. For example, the usage history of the reaction receptacle 26 includes information indicating from what dilution receptacle 23 the diluted analyte delivered into this reaction receptacle 26 was aspirated, information indicating what analyte was used as the diluted analyte in the reaction receptacle 26, and information indicating what item was measured regarding the reactant received in the reaction receptacle 26.

What is displayed in the item of Reaction Cell Usage History W3 is information about various items including No., Date and Time, Analyte ID, Probe Type, Item Name, Suction Source, Delivery Destination, and Dilution Conditions. Serial numbers attached in order of measurements of analytes are displayed in the item of No. The date and time at which a diluted analyte was aspirated from one dilution receptacle 23 is displayed in the item of Date and Time. The analyte ID of an analyte to be measured is displayed in the item of Analyte ID. What is displayed in the item of Probe Type is the type of the diluted analyte sampling probe 8 for dispensing an aliquot of diluted analyte into one reaction receptacle 26 from one dilution receptacle 23.

What is displayed in each item of Item Name is a measurement item for an analyte. What is displayed in each item of Suction Source is an identification number given to one dilution receptacle 23 from which a diluted analyte was aspirated by the diluted analyte sampling probe 8. What is displayed in each item of Delivery Destination is an identification number given to the reaction receptacle 26 into which the diluted analyte sampling probe 8 has delivered a diluted analyte. What is displayed in each item of Dilution Conditions are dilution conditions under which an analyte is diluted in one dilution receptacle 23. For example, dilution condition “M” indicates that an analyte will be diluted by a normal dilution factor.

The record W3a of the reaction cell usage history W3 displayed in highlighted form shows from what dilution receptacle 23 the diluted analyte received, for example, in the 52nd reaction receptacle 26 that is a delivery destination has been drawn in. Therefore, the laboratory technician can see that an analyte has been measured using what measurement items around the date and time at which the analyte was measured in terms of the measurement items. Consequently, the technician can judge the presence or absence of the effects of the reagent used in the measurement.

In the second embodiment described so far, if the cell usage history button W2d of the detailed result viewer W2 is depressed, the reaction cell usage history W3 is displayed. Therefore, the laboratory technician can know the measurement items of the analyte measured in the past by the use of the reaction receptacle 26 receiving the analyte instructed to be retested by viewing the reaction cell usage history W3. Consequently, it is easy for the technician to make a decision as to whether the item of the analyte instructed to be retested by the host device 50 has been affected by the analyte received in the reaction receptacle or by the reagent used in the past according to measurement items, i.e., whether the reaction receptacle 26 has been contaminated.

### <2-3. Example of Display of Usage History of Dilution Cell>

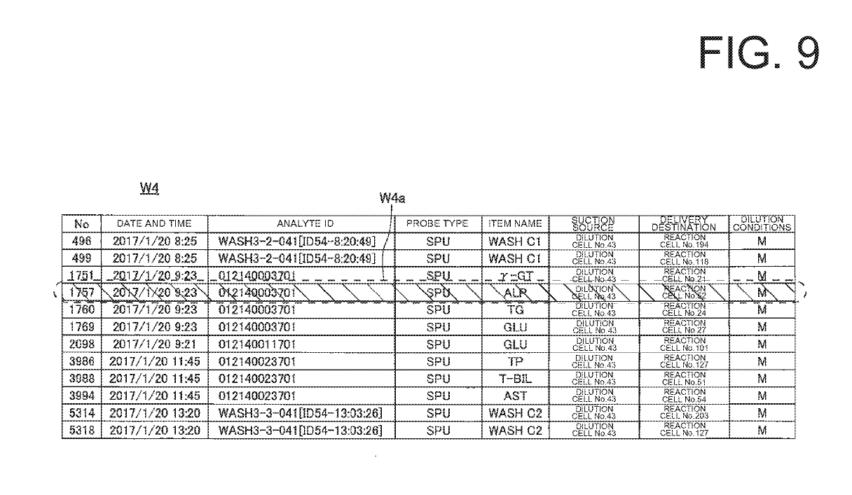

It is advantageous to check the usage history of the dilution receptacle 23 as well as the reaction receptacle 26 when the laboratory technician makes a decision as to whether the item of the analyte instructed to be retested has been contaminated. Therefore, if the cell usage history button W2d shown in the detailed result viewer W2 of FIG. 7 is depressed, the dilution cell usage history W4 shown in FIG. 9 may be displayed.

FIG. 9 is an explanatory view illustrating an example of display of the dilution cell usage history W4. When instructions for displaying the usage history of the dilution receptacle 23 are given through the detailed result viewer W2, the control section 41 displays, on the display unit 44, both dilution receptacle position information indicating the position of the dilution receptacle 23, receiving the diluted analyte dispensed prior to issuance of instructions for retesting from the host device 50, on the dilution turntable 3 and the usage history of the dilution receptacle 23. The usage history of the dilution receptacle 23 referred to herein is information represented at every date and time at which the diluted analyte sucked, for example, from a certain dilution receptacle 23 is delivered to any reaction receptacle 26. The usage history of the dilution receptacle 23 includes, for example, information indicating into what reaction receptacle 26 the diluted analyte aspirated from this dilution receptacle 23 is delivered, information indicating what analyte was used as a diluted analyte in the dilution receptacle 23, and information indicating what item is measured regarding the reactant dispensed into the reaction receptacle 26 from this dilution receptacle 23.

Information about various items including No., Date and Time, Analyte ID, Probe Type, Item Name, Suction Source, Delivery Destination, and Dilution Conditions is shown in the dilution cell usage history W4. The information contents displayed in various items of the dilution cell usage history W4 are identical to the information contents displayed at various items of the reaction cell usage history W3 shown in FIG. 8.

Owing to the record W4a of the dilution cell usage history W4 which is displayed in highlighted form, the laboratory technician can confirm both the information about the analyte aliquot dispensed, for example, before or after the 43rd dilution receptacle 23 that is a suction source and the results of analysis and make a decision as to whether analytes used in measurements conducted in the past have caused contamination.

Because the dilution cell usage history W4 is displayed in this way, the laboratory technician can know what analytes were received in the past in the dilution receptacle 23 into which an analyte instructed to be retested will be received. Therefore, it is easy for the technician to make a decision as to whether the diluted analyte which is instructed to be retested and which is received in the dilution receptacle 23 has been contaminated by the dilution receptacle 23.

### 3. Modifications to Embodiments

If the biochemical analyzer 1 is equipped with none of the dilution turntable 3, diluted analyte sampling probe 8, dilution and stirring mechanism 9, and dilution receptacle cleaning mechanism 11, the operation for adding a diluent to an analyte to dilute it is not performed. In this case, the undiluted analyte sampling probe 7 intact aliquots the analyte aspirated from any sample receptacle 21 into a selected one of the reaction receptacles 26 on the reaction turntable 6. Then, a first reagent is dispensed into the reaction receptacles 26 by the first reagent dispensing probe 12. A second reagent is dispensed as aliquots into the reaction receptacles 26 by the second reagent dispensing probe 13. The multi-wavelength photometer 16 performs optical measurements on the analyte which has reacted with the first and second reagents and detects the state of reaction of the analyte.

Two cell usage history buttons W2d may be provided to display both the reaction cell usage history W3 and the dilution cell usage history W4 in the detailed result viewer W2. For example, if the reaction cell usage history button is depressed, the reaction cell usage history W3 may be displayed. If the dilution cell usage history button is depressed, the dilution cell usage history W4 may be displayed.

If it is determined that the reaction receptacle 26 receiving the analyte instructed to be retested has been contaminated, the biochemical analyzer 1 may provide control so as to clean this contaminated reaction receptacle 26 plural times. Consequently, the reaction receptacle 26 is cleaned sufficiently, and the effects of contamination can be eliminated.

In the above-described embodiments, an automated analyzer is applied to the biochemical analyzer 1. An automated analyzer may also be applied to other instrument such as an immunological analyzer.

It is to be understood that the present invention is not restricted to the foregoing embodiments but rather various other applications and modifications are possible without departing from the gist of the present invention set forth in the appended claims. For example, in the foregoing embodiments, the configurations of equipment and system are described in detail and specifically to facilitate understanding the present invention. The invention is not restricted to an instrument equipped with all the configurations described above. Furthermore, a part of the configuration of some embodiment described herein may be replaced with the configuration of other embodiment. In addition, the configuration of other embodiment may be added to the configuration of some embodiment. Further, with respect to parts of each embodiment, other configurations may be added. Some parts of each embodiment may be deleted or replaced with other configuration.

Additionally, control lines and information lines which are considered necessary for illustrative purposes are shown. Note that not all control lines and information lines of the article of manufacture are shown. In practice, it may be considered that almost all configurations are interconnected.

1. An automated analyzer comprising:
a display unit;
a communication section capable of communicating with a host device;
an analyte receptacle holding section for holding an analyte receptacle that receives an analyte to be measured;
a reagent receptacle holding section for holding a reagent receptacle that receives a reagent;
a reaction receptacle holding section for holding a reaction receptacle in which the analyte and the reagent are stirred together;
an analyte dispenser for aspirating the analyte from the analyte receptacle and dispensing an aliquot of the analyte into the reaction receptacle;
a reagent dispenser for aspirating the reagent from the reagent receptacle and dispensing an aliquot of the reagent into the reaction receptacle;
a measurement section for measuring, at given measurement cycles, a reactant produced by reaction of the aliquot of the analyte in the reaction receptacle with the reagent; and
a control section operative to output results of analysis of measurement values from the reactant measured by the measurement section to the host device through the communication section and to cause both analyte identification information for identification of the analyte instructed to be retested from the host device through the communication section and analyte receptacle positional information indicative of position of the analyte receptacle receiving the analyte instructed to be retested from the host device on or in the analyte receptacle holding section to be displayed on the display unit.

2. The automated analyzer as set forth in claim 1, wherein said analyte receptacle holding section is at least one of a turntable holding said analyte receptacle and a rack device holding said analyte receptacle.

3. The automated analyzer as set forth in claim 2, wherein the display unit is configured to show a progress monitor providing a display of both a status of analysis of said analyte and said analyte receptacle positional information, and wherein said control section displays, in said progress monitor, information indicating that said analyte is instructed to be retested from said host device.

4. The automated analyzer as set forth in claim 3, wherein when results of display of said analyte identified by information indicating that it is instructed to be retested from said host device is instructed to be displayed through said progress monitor, said control section displays, on said display unit, an analysis result display screen providing a display of said results of analysis.

5. The automated analyzer as set forth in claim 4, wherein when usage history of said reaction receptacle is instructed to be displayed through said analysis result display screen, said control section displays, on the display unit, both reaction receptacle positional information indicating position of the reaction receptacle, receiving said reactant instructed to be retested from said host device, on or in said reaction receptacle holding section and the usage history of the reaction receptacle.

6. The automated analyzer as set forth in claim 4, further comprising; a dilution receptacle holding section for holding a dilution receptacle receiving the analyte that has been diluted with a diluent; and a diluted analyte dispenser for aspirating the diluted analyte from the dilution receptacle and dispensing an aliquot of the diluted analyte into the reaction receptacle, and wherein said analyte dispenser aspirates the analyte from the analyte receptacle and dispenses an aliquot of the analyte into the dilution receptacle, thus preparing said diluted analyte.

7. The automated analyzer as set forth in claim 6, wherein when usage history of said dilution receptacle is instructed to be displayed through said analysis result display screen, said control section causes both dilution receptacle positional information indicative of a position of the dilution receptacle receiving the diluted analyte dispensed as an aliquot before instructions for retesting are issued from said host device and the usage history of the dilution receptacle to be displayed on said display unit.

8. A retesting instruction system having an automated analyzer and a host device, wherein said automated analyzer comprises:
a first display unit;
a first communication section capable of communicating with the host device;
an analyte receptacle holding section for holding an analyte receptacle receiving an analyte under measurement;
a reagent receptacle holding section for holding a reagent receptacle receiving a reagent;
a reaction receptacle holding section for holding a reaction receptacle in which the analyte and the reagent are stirred together;
an analyte dispenser for aspirating the analyte from the analyte receptacle and dispensing an aliquot of the analyte into the reaction receptacle;
a reagent dispenser for aspirating the reagent from the reagent receptacle and dispensing an aliquot of the reagent into the reaction receptacle;
a measurement section for measuring, at given measurement cycles, a reactant produced by reaction of the aliquot of the analyte dispensed in the reaction receptacle with the reagent; and
a first control section for outputting results of analysis of measurement values from the reactant measured by the measurement section to the host device through the first communication section and causing both analyte identification information for identifying the analyte instructed to be retested from the host device through the first communication section and analyte receptacle positional information indicative of a position of the analyte receptacle receiving the analyte instructed to be retested from the host device to be displayed on the first display unit;
and wherein said host device comprises:
a second communication section capable of communicating with the first communication section of said automated analyzer;
a second display unit for displaying the results of analysis received by the second communication section from the automated analyzer;
an input section for entering instructions for retesting of the analyte; and
a second control section for causing the instructions for retesting of the analyte entered from the input section to be transmitted to the automated analyzer from the second communication section.
